(19) United States
(12) Patent Application Publication
(10) Pub. No.: US 2019/0369927 A1
(43) Pub. Date: Dec. 5, 2019

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Masahiko YAJIMA, Kanagawa (JP)

(73) Assignee: FUJI XEROX CO., LTD., Tokyo (JP)

(21) Appl. No.: 16/352,854

(22) Filed: Mar. 14, 2019

(30) Foreign Application Priority Data
Jun. 4, 2018 (JP) 2018-107108

(51) Int. Cl. G06F 3/12

(52) U.S. Cl. CPC G06F 3/1206; G06F 3/1245; G06F 3/1282; G06F 3/1251

(57) ABSTRACT

An information processing apparatus includes a receiver that receives print data including a common image used in common over plural pages, a divider that divides the print data received by the receiver based on each type of the common image in use, and an adjuster that performs adjustment by redividing or combining pieces of the print data of each type of the common image that is divided by the divider so that a data amount of each piece of the divided print data becomes equal to or smaller than an upper limit value set in advance.

### CROSS-REFERENCE TO RELATED APPLICATIONS

This application is based on and claims priority under 35 USC 119 from Japanese Patent Application No. 2018-107108 filed Jun. 4, 2018.

### BACKGROUND

### (i) Technical Field

The present disclosure relates to an information processing apparatus and a non-transitory computer readable medium storing a program.

### (ii) Related Art

Japanese Unexamined Patent Application Publication No. 2006-209508 discloses a printing system in which a print server divides a print job received from a client terminal on a page basis and transmits the print job divided on a page basis to a printer.

### SUMMARY

Aspects of non-limiting embodiments of the present disclosure relate to an information processing apparatus and a non-transitory computer readable medium storing a program, in which print data including a common image used in common over a plurality of pages may be divided so that the data amount of the print data becomes equal to or smaller than an upper limit value set in advance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a receiver that receives print data including a common image used in common over a plurality of pages, a divider that divides the print data received by the receiver based on each type of the common image in use, and an adjuster that performs adjustment by redividing or combining pieces of the print data of each type of the common image that is divided by the divider so that a data amount of each piece of the divided print data becomes equal to or smaller than an upper limit value set in advance.

### BRIEF DESCRIPTION OF THE DRAWINGS

An exemplary embodiment of the present disclosure will be described in detail based on the following figures, wherein:

FIG. 1 illustrates the system configuration of a printing system of one exemplary embodiment of the present disclosure;

FIG. 2 illustrates the reason why a conversion processing server performs PDL conversion processing;

FIG. 3 illustrates the reason why the conversion processing server performs the PDL conversion processing;

FIG. 4 illustrates a specific example of a case in which the data amount of each piece of divided print data is not equal to or smaller than an upper limit value if the print data is divided based only on a page count;

FIG. 5 is a block diagram illustrating the hardware configuration of the conversion processing server of the exemplary embodiment of the present disclosure;

FIG. 6 is a block diagram illustrating the functional configuration of the conversion processing server of the exemplary embodiment of the present disclosure;

FIG. 7 is a flowchart for illustrating an overall operation of the conversion processing server;

FIG. 8 is a flowchart for illustrating details of PDL conversion processing for print data described by a PDL unique to Company A in the flowchart of FIG. 7;

FIG. 9 is a flowchart for illustrating details of pre-scanning processing for spooled print data in the flowchart of FIG. 8;

FIG. 10 illustrates an example of specific print data to be subjected to division processing;

FIG. 11 illustrates a concept of print results obtained by using the print data illustrated in FIG. 10;

FIG. 12 illustrates form usage information generated based on the print data illustrated in FIG. 10;

FIG. 13 illustrates an example of a resource management table;

FIG. 14 illustrates an example of processing of calculating a division count to be used when each piece of divided print data is redivided;

FIGS. 15A and 15B illustrate how the print data is redivided based on the calculated division count;

FIGS. 16A and 16B illustrate how the print data is redivided based on the calculated division count; and

FIG. 17 illustrates how two pieces of print data are combined.

### DETAILED DESCRIPTION

An exemplary embodiment of the present disclosure is described in detail with reference to the drawings.

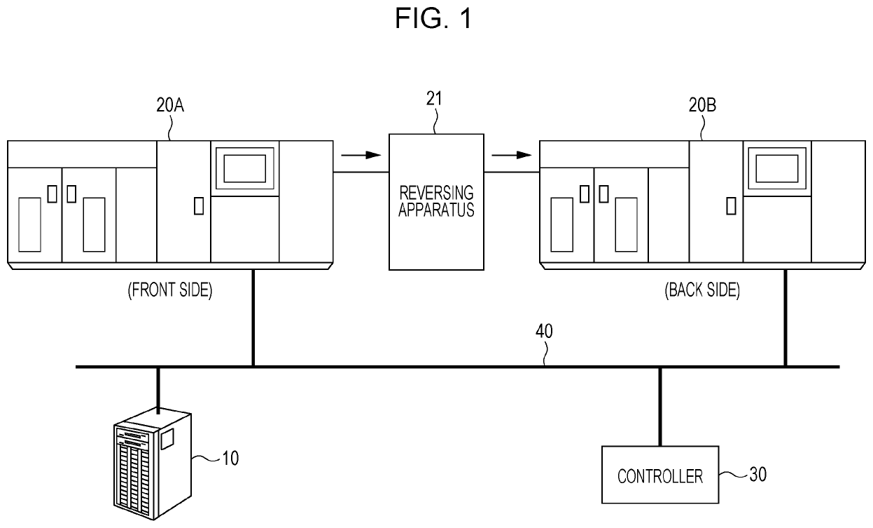

FIG. 1 illustrates the system configuration of a printing system of one exemplary embodiment of the present disclosure.

As illustrated in FIG. 1, an image forming system of the exemplary embodiment of the present disclosure is configurated by a conversion processing server (converter) 10, two printers 20A and 20B, and a controller 30 that are connected to each other via a network 40, and is also configurated by a reversing apparatus 21.

The printers 20A and 20B in the printing system of this exemplary embodiment are continuous paper printers that perform printing on so-called continuous paper. The printer 20A is provided for printing on a front side of the continuous paper. The printer 20B is provided for printing on a back side of the continuous paper. The continuous paper whose front side has been subjected to printing by the printer 20A is reversed by the reversing apparatus 21 and supplied to the printer 20B.

The controller 30 controls the printers 20A and 20B to execute printing processing based on received print data (print job).

The conversion processing server 10 performs processing of converting print data described by a certain page description language (PDL) to print data described by a PDL different from the certain PDL, such as a general-purpose PDL in a PostScript (registered trademark) format (hereinafter abbreviated as a PS format) or the like. The print data format is not limited to the PDL. For example, the print data may be a text data sequence in a format such as comma-separated values (CSV).

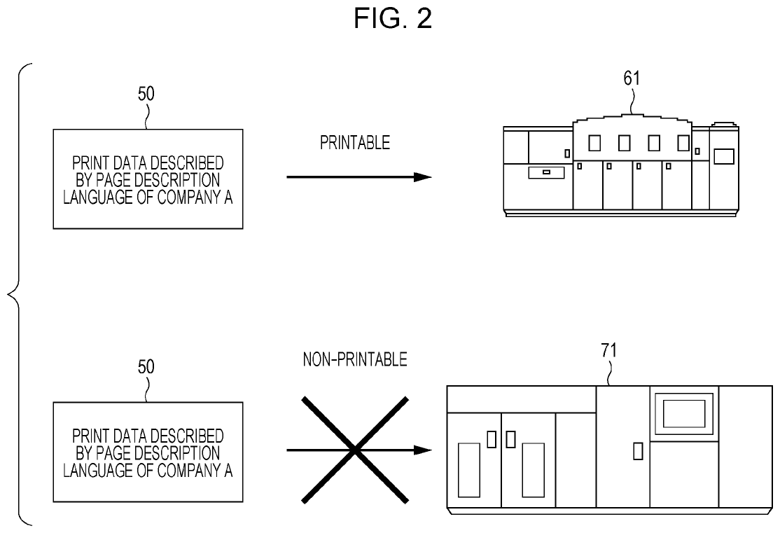

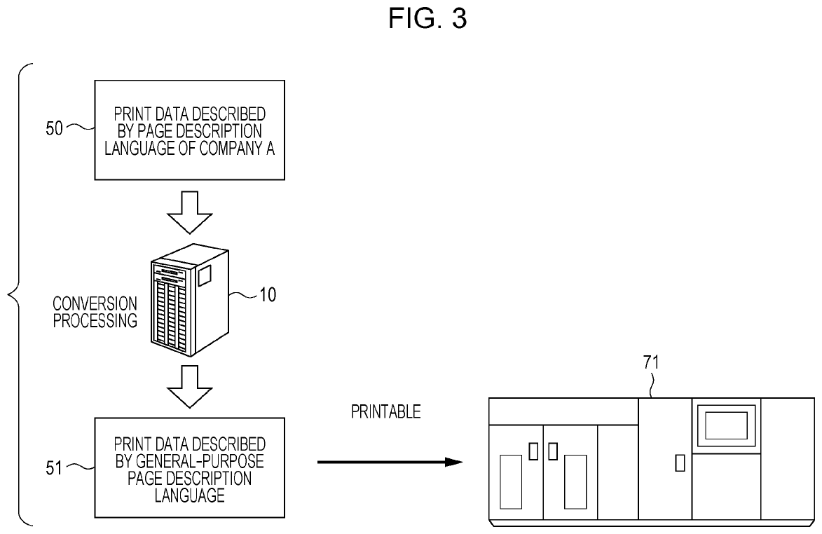

The reason why the conversion processing server 10 performs the PDL conversion processing is described with reference to FIG. 2 and FIG. 3.

In an output business in which large-quantity and high-speed printing processing is required, the continuous paper printer is often used. In the continuous paper printer for business use, the printing processing is performed by using print data described by a dedicated PDL unique to each manufacturer. The print data described by a dedicated PDL unique to each manufacturer is often used not only in the continuous paper printer but also in printers that may perform high-speed printing processing for business.

As illustrated in FIG. 2, there is a possibility that printing processing that uses print data 50 described by a page description language of Company A is executable in a printer 61 of Company A but not in a printer 71 of Company B.

Therefore, when printing processing that uses print data described by a PDL of a certain manufacturer is performed in a printer of a different manufacturer, it is necessary to create print data again in a format in which the printer of the different manufacturer may perform printing. To eliminate such time and effort, as illustrated in FIG. 3, the conversion processing server 10 performs processing of converting the print data 50 described by the page description language of Company A to, for example, print data 51 described by a general-purpose page description language.

The print data 51 described by a general-purpose page description language may be interpreted by the printer 71 of Company B. Thus, the printer 71 of Company B may execute the printing processing.

In general, printers convert print data described by various PDLs to raster images by raster image processors (RIPs) corresponding to the types of the PDLs. For example, print data described by PostScript (registered trademark) is converted to a raster image by a RIP called Configurable PostScript Interpreter (CPSI). Print data described by Portable Document Format (PDF) is converted to a raster image by a RIP called Adobe PDF Print Engine (APPS).

In those RIPs, an upper limit may be provided for the data amount of processable print data. If the printer has received print data whose data amount exceeds the upper limit, a problem arises in that the RIP fails to process the received print data and the printing processing is not executable.

When the conversion processing server 10 converts the print data 50 described by the page description language of Company A to the print data 51 described by a general-purpose page description language, it is necessary to divide the print data so that the data amount becomes equal to or smaller than an upper limit value set in a RIP that processes the general-purpose page description language.

When the print data is divided so that the data amount becomes equal to or smaller than the upper limit value set in advance, there is a possibility that the data amount of each piece of the divided print data is not equal to or smaller than the upper limit value if the print data is divided based only on a page count.

For example, when print data including a common image such as a common form image used in common over a plurality of pages is divided so that the data amount becomes equal to or smaller than the upper limit value set in advance, there is a possibility that the data amount of each piece of the divided print data is not equal to or smaller than the upper limit value if the print data is divided based only on the page count.

For example, the common image refers to various images of a form and a graphical object such as a mark of a logotype of a company, which are used in common over a plurality of pages. The common image is prepared separately from data on print contents of each page. In each page, the common image may be used as the print contents of each page by simply specifying the use of the common image.

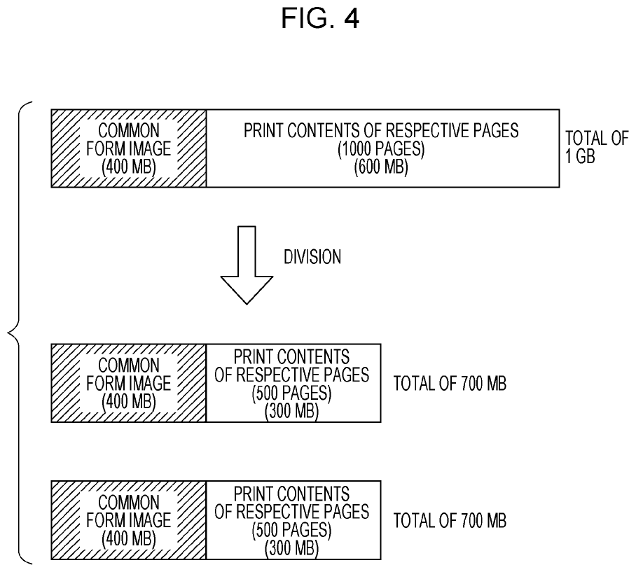

Referring to FIG. 4, description is made of a specific example of a case in which the data amount of each piece of the divided print data is not equal to or smaller than the upper limit value if the print data is divided based only on a page count. In the specific example illustrated in FIG. 4, description is made of exemplary print data in which the total page count is 1000 and the total data amount is 1 GB including 400 MB for a common form image and 600 MB for print contents of respective pages.

It is supposed that the print data will be divided so that the data amount of each piece of the divided print data becomes equal to or smaller than 500 MB. If the print data is divided based simply on the page count, it is appropriate to divide the original print data into two parts because 1 GB/500 MB=2. That is, it is appropriate to divide the data having 1000 pages into pieces of print data each having 500 pages.

When the print data illustrated in FIG. 4 is divided into two parts, the common form image is necessary in each piece of the divided print data. Therefore, each piece of the divided print data has a total data amount of 700 MB including 400 MB for the common form image and 300 MB for the print contents of the respective pages. That is, in the case illustrated in FIG. 4, the data amount is not equal to or smaller than the upper limit value of 500 MB if the print data is divided based only on the page count.

Therefore, the conversion processing server 10 of this exemplary embodiment divides the print data including the common image so that the data amount becomes equal to or smaller than the upper limit value set in advance without dividing the print data based only on the page count.

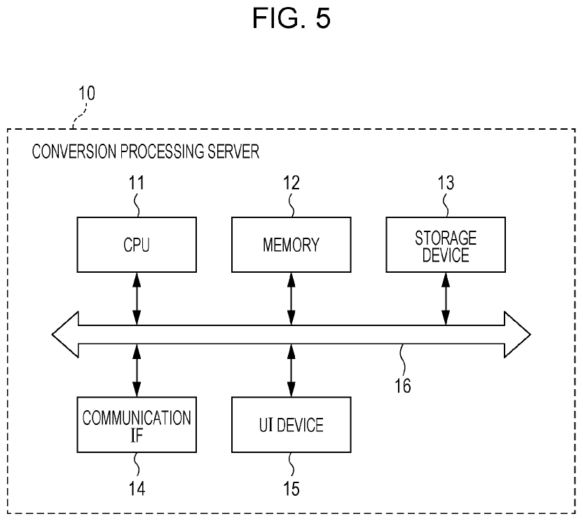

FIG. 5 illustrates the hardware configuration of the conversion processing server 10.

As illustrated in FIG. 5, the conversion processing server 10 includes a CPU 11, a memory 12, a storage device 13 such as a hard disk drive (HDD), a communication interface (IF) 14 that exchanges data with an external apparatus or the like via the network 40, and a user interface (UI) device 15 including a touch panel or a liquid crystal display and a keyboard. Those components are connected to each other via a control bus 16.

The CPU 11 controls an operation of the conversion processing server 10 by executing predetermined processing based on a control program stored in the memory 12 or the storage device 13. In this exemplary embodiment, description is made under the assumption that the CPU 11 reads and executes the control program stored in the memory 12 or the storage device 13. The program may be provided to the CPU 11 by being stored in a storage medium such as a CD-ROM.

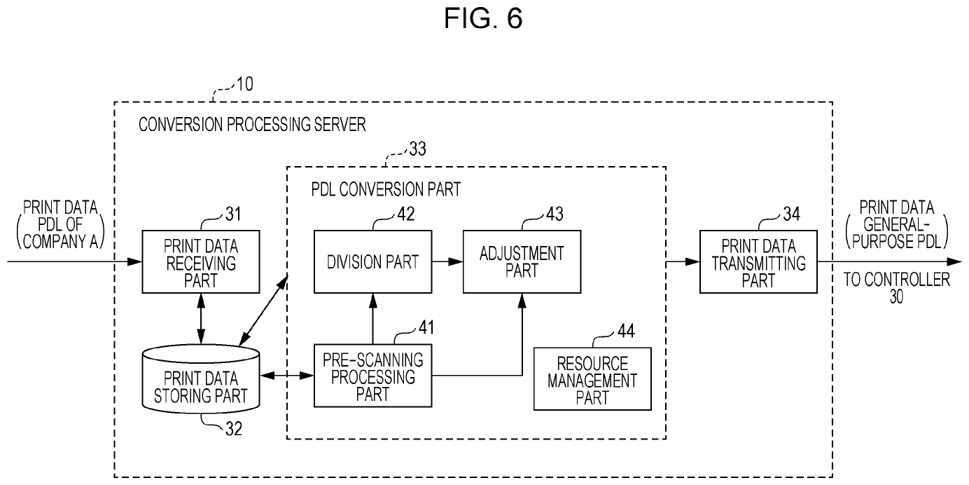

FIG. 6 is a block diagram illustrating the functional configuration of the conversion processing server 10 that is implemented by executing the control program.

As illustrated in FIG. 6, the conversion processing server 10 of this exemplary embodiment includes a print data receiving part 31, a print data storing part 32, a PDL conversion part 33, and a print data transmitting part 34.

For example, the print data receiving part 31 receives print data described by the PDL unique to Company A from the controller 30 or a recording medium such as a CD-ROM. The print data includes a common image such as a common form image or a common graphical object. The print data receiving part 31 functions as a receiver that receives print data including a common image. The common image refers to various images of a form and a graphical object that are used in common over a plurality of pages.

The print data storing part 32 spools (stores) the print data received by the print data receiving part 31.

The PDL conversion part 33 converts the print data received by the print data receiving part 31, stored in the print data storing part 32, and described by the PDL unique to Company A to print data described by a description language different from this PDL, such as a PDL in the PS format that is a general-purpose description language that does not depend on a printer that executes printing processing.

The print data transmitting part 34 transmits, to the controller 30, the print data described by the general-purpose PDL through the conversion performed by the PDL conversion part 33.

The PDL conversion part 33 includes a pre-scanning processing part 41, a division part 42, an adjustment part 43, and a resource management part 44.

The pre-scanning processing part 41 executes pre-scanning processing for the print data stored in the print data storing part 32 to investigate the page structure of the print data stored in the print data storing part 32 and the usage of the common image in each page, thereby generating form usage information.

The division part 42 divides the print data received by the print data receiving part 31 and stored in the print data storing part 32 based on each type of the common image in use. The division of the print data is not limited to actual division of the print data into a plurality of pieces of print data but encompasses tentative determination of division candidate locations. That is, the division part 42 determines candidate locations where the print data stored in the print data storing part 32 is divided into a plurality of pieces of print data based on each type of the common image in use.

The division part 42 divides the print data stored in the print data storing part 32 based on each type of the common image in use by using the form usage information that is an investigation result from the pre-scanning processing part 41.

The adjustment part 43 performs adjustment by redividing or combining the plurality of pieces of the print data of each type of the common image that is divided by the division part 42 so that the data amount of each piece of the print data becomes equal to or smaller than the upper limit value set in advance.

The upper limit value set in advance refers to a value limited in the processing to be performed by the RIP such as CPSI when print data is converted to a raster image in the controller 30 or in the printers 20A and 20B that execute printing processing based on the print data.

When the data amount of each piece of the divided print data of each type of the common image exceeds the upper limit value, the adjustment part 43 redivides each piece of the divided print data so that the data amount becomes equal to or smaller than the upper limit value in a state in which the common image is included in each piece of the divided print data.

Specifically, the adjustment part 43 redivides each piece of the print data of each type of the common image by a division count that is calculated by dividing the data amount of data other than the common image in each piece of the divided print data of each type of the common image by a value obtained by subtracting the data amount of the common image from the upper limit value.

At this time, the adjustment part 43 redivides each piece of the divided print data of each type of the common image at a boundary between pages. When imposition processing is performed, the adjustment part 43 redivides each piece of the divided print data of each type of the common image at a boundary between physical pages.

The imposition processing refers to processing of performing printing so that a plurality of logical pages are included in one physical page. The physical page refers to a page on actual print paper. The logical page refers to each page arranged within one physical page instead of the page on actual print paper.

When the data amount of each piece of the divided print data of each type of the common image is equal to or smaller than the upper limit value and when the total of the data amount of each piece of the divided print data of each type of the common image and the data amount of a subsequent piece of the divided print data of each type of the common image is equal to or smaller than the upper limit value, the adjustment part 43 combines the plurality of pieces of the divided print data of each type of the common image.

The resource management part 44 manages various types of information such as resource names and data sizes of various common images such as a common form image and a common graphical object image. A specific example of how the resource management part 44 manages various types of information on the common images is described later.

Next, an operation of the conversion processing server 10 in the printing system of this exemplary embodiment is described in detail with reference to the drawings.

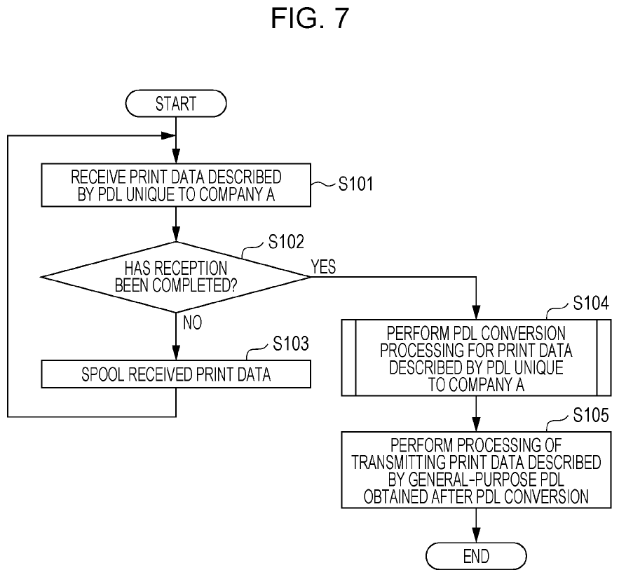

First, an overall operation of the conversion processing server 10 is described with reference to FIG. 7.

When the print data receiving part 31 has received print data described by the PDL unique to Company A (Step S101), the received print data is stored in the print data storing part 32 until the reception of all the print data is completed (Steps S102 and S103).

When the reception of all the print data has been completed (“YES” in Step S102), the PDL conversion part 33 performs PDL conversion processing for converting the print data described by the PDL unique to Company A to print data described by a general-purpose PDL in the PS format or the like (Step S104).

Finally, the print data transmitting part 34 transmits the print data described by the general-purpose PDL to the controller 30 (Step S105).

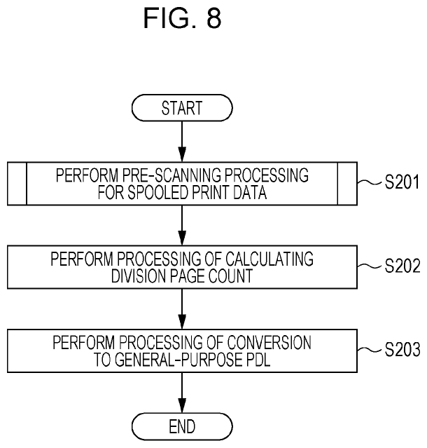

Next, details of the PDL conversion processing for the print data described by the PDL unique to Company A in the flowchart of FIG. 7 (Step S104) are described with reference to a flowchart of FIG. 8.

In the PDL conversion part 33, the pre-scanning processing part 41 first executes pre-scanning processing for the print data spooled in the print data storing part 32 (Step S201).

In the pre-scanning processing, contents of each page of the spooled print data are interpreted to generate form usage information indicating the page structure of the print data and a common form image specified in each page. The following description is directed to a case of using the common form image as the common image. The same applies to a case of using a common image other than the common form image. Details of the pre-scanning processing are described later.

When the pre-scanning processing is finished, processing of calculating a division page count is performed (Step S202). The division page count refers to a page count at which the print data is divided. That is, a page location where the print data is divided is determined in the processing of calculating the division page count.

In the processing of calculating the division page count, the division part 42 first divides the print data stored in the print data storing part 32 based on each type of the common image in use by using the form usage information that is the investigation result from the pre-scanning processing part 41. When the data amount of each piece of the print data of each type of the common image that is divided by the division part 42 exceeds the upper limit value, the adjustment part 43 redivides each piece of the divided print data so that the data amount becomes equal to or smaller than the upper limit value in a state in which the common image is included in each piece of the divided print data. When the data amount of each piece of the divided print data is small and therefore the data amount does not exceed the upper limit value even if two or more pieces of the print data are combined, the adjustment part 43 performs processing of combining the plurality of pieces of the divided print data.

Through the processing performed by the division part 42 and the adjustment part 43, a division page location where the data amount becomes equal to or smaller than the upper limit value among all the pieces of the divided print data is determined.

The PDL conversion part 33 executes conversion processing for converting the print data described by the PDL unique to Company A to print data described by a general-purpose PDL in a state in which the print data is divided based on the division page location determined as described above (Step S203).

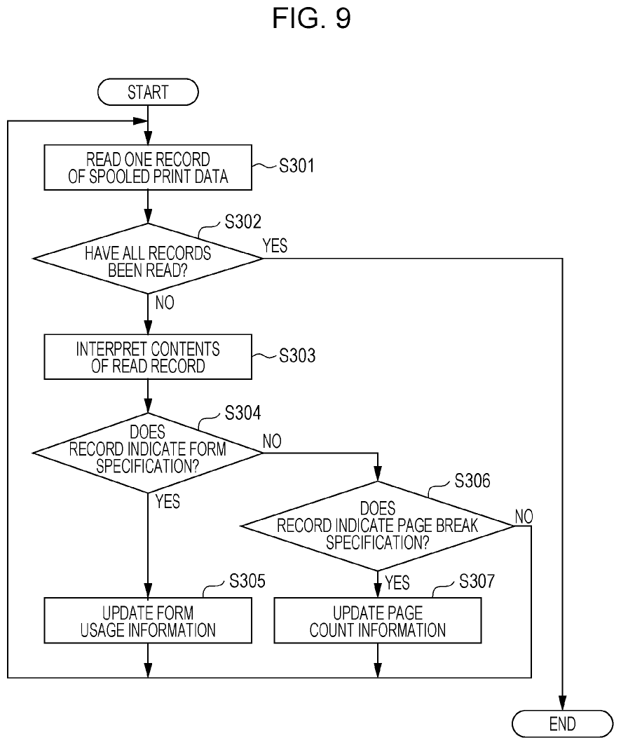

Next, details of the pre-scanning processing for the spooled print data in the flowchart of FIG. 8 (S201) are described with reference to a flowchart of FIG. 9.

First, the pre-scanning processing part 41 reads one record of the print data spooled in the print data storing part 32 (Step S301). The record refers to a unit of print data to be stored. With one record of the print data, for example, form specification that specifies a common form image in use or page break specification that specifies page feed is performed.

The pre-scanning processing part 41 sequentially interprets contents of the read record until the reading of all the records that configurate the print data is completed (Steps S302 and S303).

When the interpreted contents of the record indicate the form specification that specifies a form in use (“YES” in Step S304), the pre-scanning processing part 41 identifies a common form image specified in the current page to be processed and updates the form usage information (Step S305).

When the interpreted contents of the record do not indicate the form specification that specifies a form in use (“NO” in Step S304), the pre-scanning processing part 41 determines whether the interpreted contents of the record indicate the page break specification (Step S306).

When the interpreted contents of the record indicate the page break specification (“YES” in Step S306), the pre-scanning processing part 41 updates page count information (Step S307). When the interpreted contents of the record do not indicate the page break specification (“NO” in Step S306), the pre-scanning processing part 41 reads a subsequent record of the print data without performing any processing (Step S301).

When the reading of all the records of the print data has been completed (“YES” in Step S302), the pre-scanning processing part 41 terminates the pre-scanning processing.

That is, in the pre-scanning processing, only the records of the form specification and the page break specification are counted to generate the form usage information.

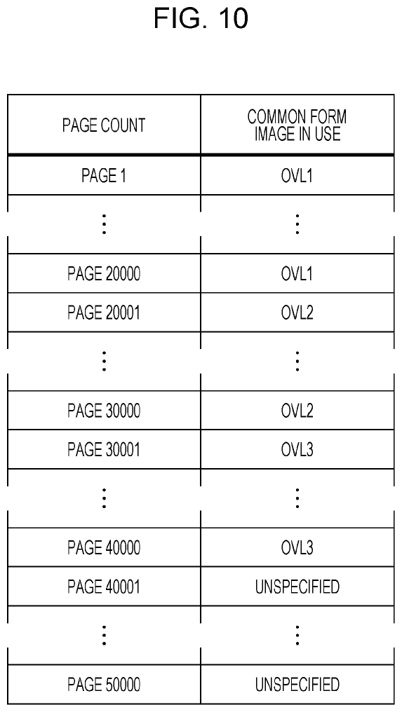

Next, a specific operation of the conversion processing server 10 is described with reference to specific print data illustrated in FIG. 10. In the following description, a plurality of common form images are represented by OVL1, OVL2, OVL3, . . .

The common form images are registered as a resource set together with other common images. When the common form image is registered in the resource set in advance, a common form image used in the print data is specified. A packet called download form is present as a packet for specifying the common form image used in the print data. When the print data is received and the download form packet is recognized in the received print data, the download form packet is extracted, converted dynamically to a common form image in the PS format, and stored in the resource set. When the common form image used in the print data is similarly specified afterwards, the form registered in the resource set is used.

In the example of the print data illustrated in FIG. 10, the common form image OVL1 is used in pages 1 to 20000, the common form image OVL2 is used in pages 20001 to 30000, the common form image OVL3 is used in pages 30001 to 40000, and no common form image is used in pages 40001 to 50000.

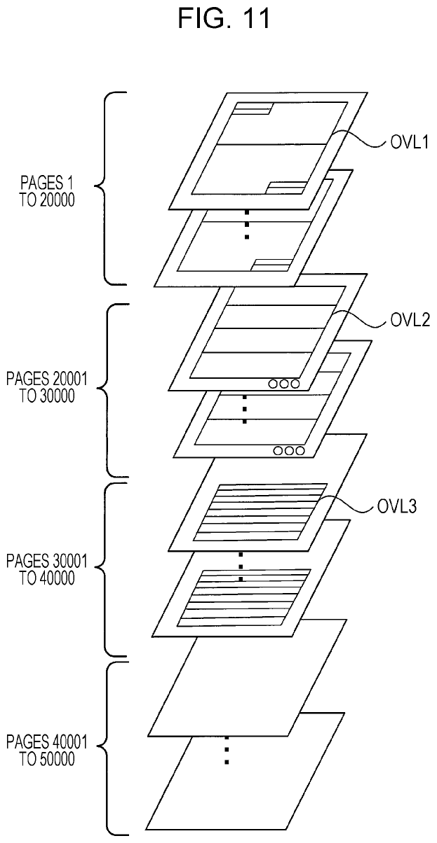

FIG. 11 illustrates a concept of print results obtained by using the print data illustrated in FIG. 10. FIG. 11 demonstrates that the common form image OVL1 is used in the print results of pages 1 to 20000, the common form image OVL2 is used in the print results of pages 20001 to 30000, the common form image OVL3 is used in the print results of pages 30001 to 40000, and no common form image is used in the print results of pages 40001 to 50000.

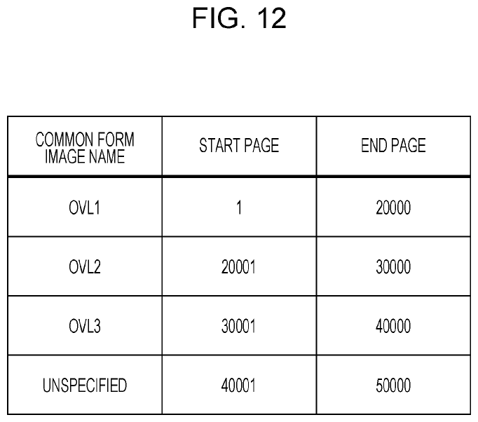

FIG. 12 illustrates form usage information generated based on the print data illustrated in FIG. 10. The form usage information illustrated in FIG. 12 demonstrates the settings of use of respective common form images in specific page ranges.

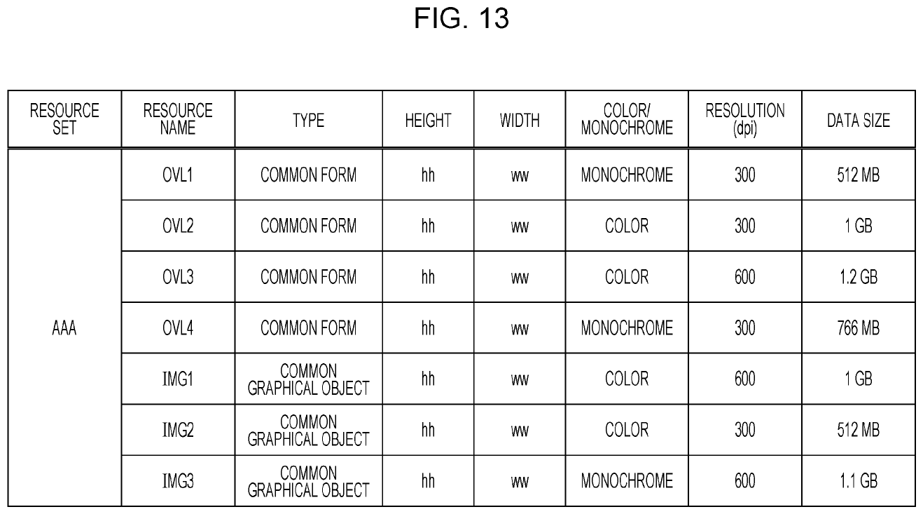

Various attributes of the common images are managed by the resource management part 44 in a resource management table illustrated in FIG. 13.

The example of the resource management table illustrated in FIG. 13 demonstrates that pieces of information on heights, widths, color or monochrome, resolutions, and data sizes are managed for common form images having resource names “OVL1” to “OVL4” and common graphical object images having resource names “IMG1” to “IMG3”.

In the division part 42 and the adjustment part 43, processing of identifying a division page location in the print data illustrated in FIG. 10 is performed by using the form usage information illustrated in FIG. 12 and the information in the resource management table illustrated in FIG. 13.

First, the division part 42 divides the print data (or determines a division candidate) based on each type of the common image in use, in this case the common form image, by referring to the form usage information illustrated in FIG. 12.

Specifically, the division part 42 divides the print data into four pieces of print data corresponding to pages 1 to 20000, pages 20001 to 30000, pages 30001 to 40000, and pages 40001 to 50000.

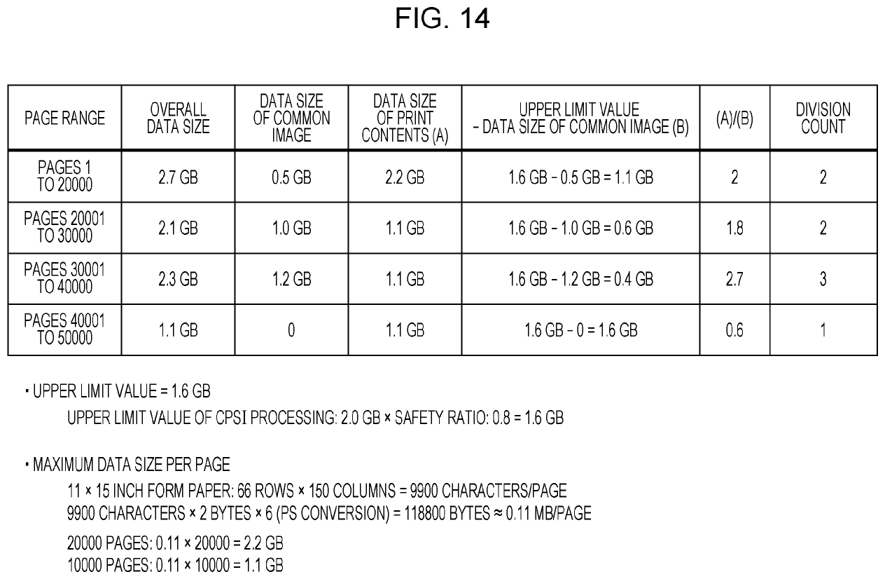

Next, the adjustment part 43 calculates a division count to be used when each of the four pieces of divided print data is redivided. FIG. 14 illustrates an example of the processing of calculating the division count.

In the example of the processing of calculating the division count in FIG. 14, the upper limit value of the data amount of each piece of the divided print data is set to 1.6 GB. The upper limit value is obtained in such a manner that 2.0 GB that is an upper limit value of processing to be performed by CPSI is multiplied by 0.8 (80%) that is a safety ratio (safety margin).

FIG. 14 illustrates a case in which the maximum data size per page is 0.11 MB. The maximum data size per page is calculated in such a manner that 9900 that is the maximum character count per page is multiplied by 2 bytes and is further multiplied by 6 in consideration of an average increase amount in the case of conversion to the PS format that is a general-purpose PDL.

For example, in a case of calculating a division count of the print data corresponding to pages 1 to 20000, the data size of the specified common form image OVL1 is first acquired from the resource management table of FIG. 13. The data size of the common form image OVL1 is 512 MB and therefore the data size of the common image is set to 0.5 GB.

The page count of the print data is 20000 and therefore the data size of print contents is set to 2.2 GB by multiplying 20000 by 0.11 MB that is the maximum data size per page.

That is, the overall data size of the print data corresponding to pages 1 to 20000 is 2.7 GB (0.5 GB+2.2 GB).

The adjustment part 42 calculates a value by subtracting the data size (data amount) of the common image from the upper limit value. The upper limit value is 1.6 GB and the data size of the common image OVL1 is 0.5 GB. Therefore, the adjustment part 42 obtains a value of 1.1 GB (B).

Next, the adjustment part 42 calculates a division count by dividing the data amount of data other than the common image in each piece of the divided print data by the value obtained in the above. Specifically, the adjustment part 42 obtains a division count of 2 (2.2 GB/1.1 GB) by dividing 2.2 GB (A) that is the data size of the print contents of the data other than the common image by 1.1 GB (B).

In the case of the print data corresponding to pages 20001 to 30000, the adjustment part 42 obtains a value of 0.6 GB by subtracting 1.0 GB that is the data size of the common image OVL2 from 1.6 GB that is the upper limit value. Then, the adjustment part 42 calculates a value of 1.8 by dividing 1.1 GB that is the data size of print contents of data other than the common image by 0.6 GB. As a result, the adjustment part 42 calculates a division count of 2 by rounding up 1.8 to an integer.

In the case of the print data corresponding to pages 30001 to 40000, the adjustment part 42 obtains a value of 0.4 GB by subtracting 1.2 GB that is the data size of the common image OVL3 from 1.6 GB that is the upper limit value. Then, the adjustment part 42 calculates a value of 2.7 by dividing 1.1 GB that is the data size of print contents of data other than the common image by 0.4 GB. As a result, the adjustment part 42 calculates a division count of 3 by rounding up 2.7 to an integer.

In the case of the print data corresponding to pages 40001 to 50000, the overall data size of the print data is 1.1 GB and is smaller than the upper limit value of 1.6 GB. Therefore, the adjustment part 43 does not redivide the print data.

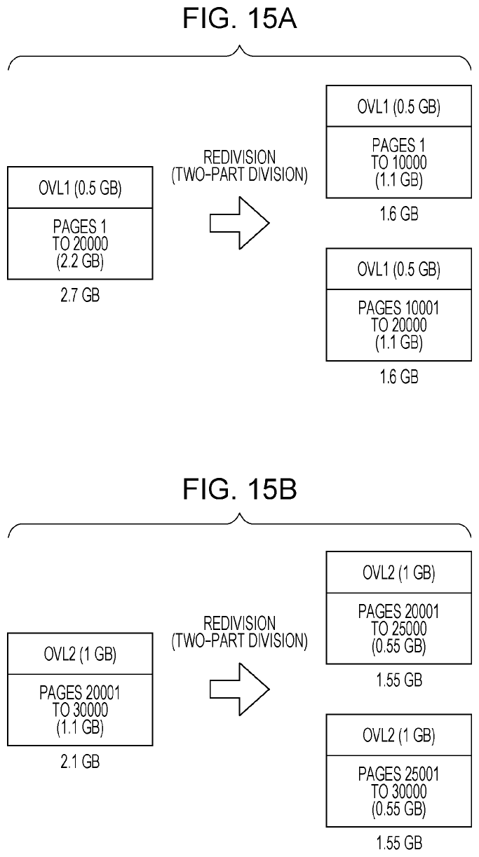

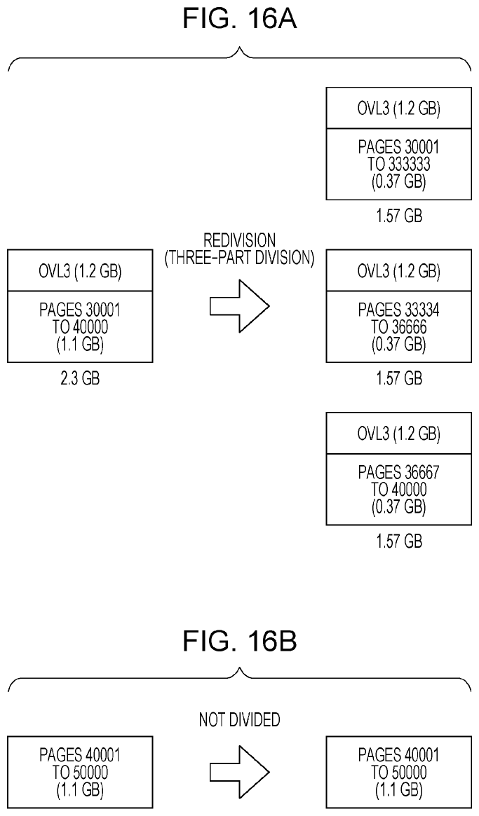

Referring to FIGS. 15A, 15B, 16A, and 16B, description is made of how the print data is redivided based on each division count calculated as described above.

FIG. 15A illustrates the case of the print data corresponding to pages 1 to 20000. It is demonstrated that the print data is divided into two pieces of print data corresponding to pages 1 to 10000 and pages 10001 to 20000 because the calculated division count is 2. Each piece of the divided print data has a total of 1.6 GB including 0.5 GB that is the data size of the common image and 1.1 GB that is the data size of the print contents of the respective pages. Therefore, it is demonstrated that the total data size is equal to or smaller than the upper limit value of 1.6 GB.

FIG. 15B illustrates the case of the print data corresponding to pages 20001 to 30000. It is demonstrated that the print data is divided into two pieces of print data corresponding to pages 20001 to 25000 and pages 25001 to 30000 because the calculated division count is 2. Each piece of the divided print data has a total of 1.55 GB including 1 GB that is the data size of the common image and 0.55 GB that is the data size of the print contents of the respective pages. Therefore, it is demonstrated that the total data size is equal to or smaller than the upper limit value of 1.6 GB.

FIG. 16A illustrates the case of the print data corresponding to pages 30001 to 40000. It is demonstrated that the print data is divided into three pieces of print data corresponding to pages 30001 to 33333, pages 33334 to 36666, and pages 36667 to 40000 because the calculated division count is 3. Each piece of the divided print data has a total of 1.57 GB including 1.2 GB that is the data size of the common image and 0.37 GB that is the data size of the print contents of the respective pages. Therefore, it is demonstrated that the total data size is equal to or smaller than the upper limit value of 1.6 GB.

As illustrated in FIG. 16B, the overall data size of the print data corresponding to pages 40001 to 50000 before redivision is 1.1 GB and is smaller than the upper limit value of 1.6 GB. Therefore, the print data is not redivided.

As described above, the print data illustrated in FIG. 10 is divided into eight pieces of print data each having a data size that does not exceed 1.6 GB.

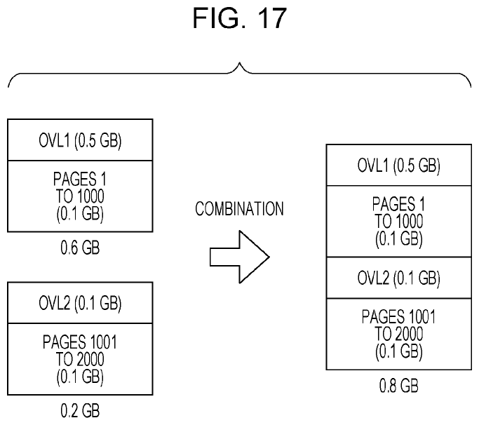

Referring to FIG. 17, description is finally made of how the adjustment part 43 combines two pieces of print data.

For example, the description is made under the assumption that the data sizes of two pieces of print data divided by the division part 42 are 0.6 GB and 0.2 GB as illustrated in FIG. 17.

In this case, the total of the data sizes of the two pieces of print data is 0.8 GB and does not exceed the upper limit value of 1.6 GB. In this case, the adjustment part 43 combines the two pieces of print data to obtain one piece of print data.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
a receiver that receives print data including a common image used in common over a plurality of pages;
a divider that divides the print data received by the receiver based on each type of the common image in use; and
an adjuster that performs adjustment by redividing or combining pieces of the print data of each type of the common image that is divided by the divider so that a data amount of each piece of the divided print data becomes equal to or smaller than an upper limit value set in advance.

2. The information processing apparatus according to claim 1, wherein, when the data amount of each piece of the divided print data of each type of the common image exceeds the upper limit value, the adjuster redivides each piece of the divided print data so that the data amount of each piece of the divided print data becomes equal to or smaller than the upper limit value in a state in which the common image is included in each piece of the divided print data.

3. The information processing apparatus according to claim 2, wherein the adjuster redivides each piece of the divided print data of each type of the common image by a division count that is calculated by dividing a data amount of data other than the common image in each piece of the divided print data of each type of the common image by a value obtained by subtracting a data amount of the common image from the upper limit value.

4. The information processing apparatus according to claim 2, wherein the adjuster redivides each piece of the divided print data of each type of the common image at a boundary between pages.

5. The information processing apparatus according to claim 3, wherein the adjuster redivides each piece of the divided print data of each type of the common image at a boundary between pages.

6. The information processing apparatus according to claim 2, wherein, when imposition processing is performed, the adjuster redivides each piece of the divided print data of each type of the common image at a boundary between physical pages.

7. The information processing apparatus according to claim 3, wherein, when imposition processing is performed, the adjuster redivides each piece of the divided print data of each type of the common image at a boundary between physical pages.

8. The information processing apparatus according to claim 1, wherein, when the data amount of each piece of the divided print data of each type of the common image is equal to or smaller than the upper limit value and when a total of the data amount of each piece of the divided print data of each type of the common image and a data amount of a subsequent piece of the divided print data of each type of the common image is equal to or smaller than the upper limit value, the adjuster combines each piece of the divided print data of each type of the common image and the subsequent piece of the divided print data of each type of the common image.

9. The information processing apparatus according to claim 1, further comprising:
a memory that stores the print data received by the receiver; and
an investigator that investigates a page structure of the print data stored in the memory and usage of the common image in each page,
wherein the divider divides the print data received by the receiver based on each type of the common image in use by using an investigation result from the investigator.

10. The information processing apparatus according to claim 1, wherein the upper limit value is a value limited in processing to be performed when the print data is converted to a raster image in a printer that executes printing processing based on the print data.

11. The information processing apparatus according to claim 1, wherein the common image is an image of a form or a graphical object that is used over the plurality of pages.

12. A non-transitory computer readable medium storing a program causing a computer to execute a process comprising:
receiving print data including a common image used in common over a plurality of pages;
dividing the received print data based on each type of the common image in use; and
performing adjustment by redividing or combining pieces of the divided print data of each type of the common image so that a data amount of each piece of the divided print data becomes equal to or smaller than an upper limit value set in advance.

13. An information processing apparatus, comprising:
reception means for receiving print data including a common image used in common over a plurality of pages;
division means for dividing the print data received by the reception means based on each type of the common image in use; and
adjustment means for performing adjustment by redividing or combining pieces of the print data of each type of the common image that is divided by the division means so that a data amount of each piece of the divided print data becomes equal to or smaller than an upper limit value set in advance.
